(19) United States
(12) Patent Application Publication
(10) Pub. No.: US 2022/0351289 A1
(43) Pub. Date: Nov. 3, 2022

(54) A REAL-TIME TRUST DISTRIBUTED MULTI ASSET CONVERTER

(71) Applicant: CENTIGLOBE AB, Sollentuna (SE)

(72) Inventors: Henrik GRADIN, SOLLENTUNA (SE); Henrik WESTERBERG, HAGERSTEN (SE)

(21) Appl. No.: 17/761,427

(22) PCT Filed: Sep. 29, 2020
(86) PCT No.: PCT/SE2020/050910

§ 371 Date: Mar. 17, 2022

(30) Foreign Application Priority Data
Sep. 30, 2019 (SE) 1951109-6

(51) Int. Cl. G06Q 40/04; G06Q 20/10; G06Q 20/38; H04L 9/00

(52) U.S. Cl. CPC G06Q 40/04; G06Q 20/10; G06Q 20/381; H04L 9/50

(57) ABSTRACT

A method and a system of exchanging assets between a plurality of parties, each party having an asset to exchange for a target asset, comprising: converting assets of each of the parties into bridge assets owned by the respective parties and represented in a transaction system, converting said system bridge assets of the respective parties to target assets requested by said parties.

### TECHNICAL FIELD

The present disclosure is, in general, directed to transaction systems and methods. More particularly, the present disclosure is directed to a system, a method and a computer program product for achieving an exchange of assets between a number of parties and for using a bridge asset, which is backed by the assets that are exchanged, as the medium of exchange. The assets are exchanged with distributed trust and in real-time.

### BACKGROUND

The exchange of goods and services has always been an integral part of civilization. The method of exchange has changed over time and as society became more complex, more complex methods had to be invented. Bartering is the method of exchanging goods and services without a medium of exchange. A barter between two parties can only be successful if they each have something the other party wants and if they can agree that the offers have the same value. Exchange of goods and services with a similar value, between two parties, has therefore always been simple. One party hands over an amount of one asset and receives the counterparty asset. However, bartering involving goods and services of different values and with more than two parties is much more complicated. The first difficulty appears when one party would like to exchange an asset of high value with one of low value. If they agree that the offers are of different value, they could either settle the difference by letting one party become indebted to the other, or by using a medium of exchange. Traditionally the one with the lower value asset would then need to be in debt to the party with the one bringing in the higher value goods or service in the exchange.

A challenging problem is if multiple parties would like to exchange assets, but there exists no counterparty to accommodate that trade or situations where bartering would involve multiple parties. For example, if one party would like to exchange item A with B, another party B with C, and yet another party item C with A. No direct exchange is then possible. To enable the trade, one solution is that all parties could gather and resolve the exchange at once. Another option is that one party first acquires an item it does not want in order to possess it temporarily, only to be able to trade it for the item it does want at a later point in time. For example, the first party exchanges first from A to C and then to B as two trades. Patent publication WO 2018096381 A1 shows that when a third party has access to all information, it can identify groups that form a closed-ring and guide the participants in making the trade. The third party can also help users value their assets and find a barter match, as shown in patent publication US 20130110681 A1. Another option is to use an unbacked point system as the medium of exchange as shown in patent publications US 20150154694 A1 and US 20100332342 A1. This however requires that each of the parties trusts the intermediary party. The risk introduced is that the intermediary party can disappear prematurely with the other parties' assets.

To solve this and other problems associated with bartering, the parties could agree on something to be a medium of exchange. Initially, societies used shells and stones, thereafter gold and national currencies. A ledger is used to keep track of balances and with the use of computer systems, the ledger has become largely automated. Most people trust national currency systems today, but there is always a central party that controls the ledger and that could, in theory, print an infinite amount of the national currency, possibly destroying the trust in the system.

In recent years, technical solutions to the above problems have been introduced with decentralized digital currencies and cryptocurrency, these technologies automate the ledger using a blockchain or similar distributed system, such that no individual party needs to be trusted. In this way, the medium of exchange is harder to manipulate and it can be easier to control its issuance. With this technology it has become possible to represent a physical or digital asset, as a token. The token is proof of ownership and can in many cases be redeemed for the asset. Another possibility is to create tokens that represent services, where the digital asset is needed to purchase a service from a system.

Bitcoin was the first notable example of a cryptocurrency. The system enables users to trust that the money supply follows a predefined inflation rate and that assets can be exchanged securely. The solution does depend on a game-theoretic model that utilizes decentralization and cryptographic proofs to secure the system rather than users having to put trust in a central party to provide the security. However, the main problem with most cryptocurrencies today is that they are fixed to a capped or limited supply. This introduces unpredictability in the value of the coins since it is directly linked to the demand and supply of the currency. This makes it problematic to use them as a medium of exchange.

To solve that problem, blockchain protocols and virtual currencies exist that instead utilize a dynamic supply and collateralization, where a collateral asset backs every circulating coin. The collateral asset could be off-chain, which requires trust in a custodian, or on-chain, which instead uses a blockchain asset. The major advantage of using on-chain collateral compared to using off-chain collateral is that anyone can perform an audit. Since the underlying collateral is oftentimes volatile, projects often try to maintain a degree of overcollateralization. A price-feed mechanism can be employed to maintain a peg to a certain exchange rate.

The methods presented above only present a partial solution to the problem of exchanging assets and goods and do not solve the complete problem. To solve the exchange problem in a more complete way with less risks, the medium of exchange could instead be a representation of the items that are being traded. In that way, it would be possible to unlock extra liquidity to make the exchange more effective. Another option is for market participants to place orders for whichever asset they want, and the distributed ledger could then resolve the request by matching participants, and if this method is used assets could be exchanged without a medium of exchange.

### OBJECT OF EMBODIMENTS

The general object of embodiments in the present disclosure is to provide a method and a system that enables a multilateral exchange in real-time and in a decentralized, trustless manner.

More specific aspects and problems are addressed by embodiments of the present disclosure, such as waiting time, temporary solutions and need to trust others assets in a system.

### SUMMARY

Embodiments of the present disclosure deal with the context that an actor wants to exchange one asset for another asset, at an exchange rate decided by the party. Assets can be goods, services, items, tokens or similar in either physical or digital representative form or as a claim on a debt. For the exchange to be performed another actor with an opposite exchange needs to exist. If no other actor exists that is able to perform the exact opposite exchange no exchange will occur. This state represents a stalemate where no actors can immediately act, henceforth this problem is referred to as the bartering problem. In a conventional bartering system the actors wait for new opportunities to arise with new actors entering the system that can fulfill their requests, they make an exchange for an asset they do not want, temporarily, to avoid a stalemate. For example when automatizing a transaction system this introduces problems of waiting time, temporary solutions and need to trust others assets in a system.

Embodiments disclosed herein provide solutions to the mentioned problems. One embodiment uses multi-asset-backed bridge assets to solve the bartering problem. A multi-asset-backed bridge asset is an asset that is backed by multiple other assets, which is here referred to as backing asset or collateral. Any kind of assets can be used as collateral, including other bridge assets.

Embodiments disclosed describes an effective way for exchanging assets, by using the medium of exchange that represents the assets, the bridge asset. In a decentralized digital system, each asset is represented by a token, and tokens can be transferred within the system.

Users can interact with the system in a number of ways: Sell order, placing an order that when matched sells an asset quantity that the user owns for a bridge asset quantity. Buy order, placing an order that when matched buys an asset quantity by selling a bridge asset quantity that the user owns. Exact trade order, placing an order that when matched sells an asset quantity that the user owns for another asset quantity, by performing an sellorder and a buy order simultaneously, such that the user is never exposed to the bridge asset.

The bridge asset is automatically generated when assets are sold. The algorithm buys the assets and sells corresponding quantities of bridge asset based on the price the assets were sold for and the quantities of assets sold. The algorithm also sells assets in exchange for bridge assets using the same but inverted mechanism, which has the effect that bridge asset supply decreases, which is defined as bridge asset liquidation. The algorithm is programmed to buy and sell bridge asset quantities proportionally to the assets the system currently owns, such that bridge assets are fungible, i.e., the bridge assets can be liquidated in such a way that each liquidation of the same size represents the same number of backing assets, if the backing is set to remain stationary. This has the effect that the bridge asset is backed by the backing assets.

The size of a bridge asset unit is defined in advance in a number of units of each collateral backing asset, i.e. where for every collateral asset quantity the system holds, the ratio between that collateral asset quantity and the circulating supply of the bridge asset is defined. The relationship between the bridge asset and the backing assets can either be stationary or change over time. When the backing is stationary, each unit of bridge asset is backed by quantities of assets, such that the ratio between each backing collateral asset quantity and the bridge asset supply remains constant when bridge assets are generated or liquidated. This is defined as the conversion relation or collateralization relation.

When bridge assets are generated or liquidated is defined as a conversion. When the backing changes over time, the ratio between the bridge asset supply and backing asset quantities may change, but after a change has been made, the system can become stationary again, and follow a new conversion relation that is based on the new backing. The system thereafter maintains a constant relationship between each bridge asset unit and the collateral units for each collateral until another change.

The collateralization relation can also be further ensured by cryptographic locks or hash proof locks, by relying on the collateralization relation.

By using a bridge asset as the medium of exchange, a system according to embodiments can solve a bartering situation involving many parties according to steps 1-5 described in FIG. 1. Actors a, b and c show their intent to exchange A for B, B for C and C for A. Each such instance is defined as a bid in a bridge asset auction. If the system agrees with the bids, according to the current backing state of the bridge asset and the conversion relation, i.e. collateral units and supply units that relate to the bridge asset, the system will accommodate the bids and transfer bridge asset quantities to the respective parties. If the system does not agree with the bids, the actors may update and continuously readjust their bids until the system does agree. When the system agree steps 1-3 has been completed.

After the first auction has been concluded, the actors have received a portion of the bridge asset. The next step is to complete steps 3-5 and convert the bridge asset to the target collateral assets, to fulfill the needs of the actors. Actors proceed to place bids for the assets they want to acquire, and when the bids align in such a way that the bridge asset can be liquidated, on the same principles that was described in the previous paragraph to maintain the collateralization relation, the system transfers the corresponding asset quantities to the actors.

The actors are able to trade without needing another actor as counterparty for each trade, instead they use the system as a counterparty and let it generate and liquidate bridge assets to accommodate them. In many embodiments, the system is built using blockchain technology to minimize the risk for the parties involved. The actors trust that the distributed decentralized system is based on sound principles rather than trusting one specific party to be the host of the system. When actors convert backing assets to bridge assets or vice versa, the system market behavior is defined as multilateral order matching, as it matches orders on several markets simultaneously accommodating several parties at once.

A system and method according to these embodiments increases the likelihood that exchanges occur. The system and the method have advantages, relative to other systems, in that it can handle the exchange of different non-exchangeable assets directly, in one or two steps, by generating and liquidating a bridge asset, . i.e., it solves the bartering problem. In addition, these embodiments can enable these exchanges to occur in real-time and be securely monitored and trusted by all parties involved in the exchange.

A system according to these embodiments can use distributed ledger technology in the form of blockchain technology or directed acyclic graphs or similar to perform trades, where a server administrator is not needed, and the server administrators actions are instead determined by an algorithm. Alternatively, the server administrators could follow a decentralized protocol. By designing a system this way, users do not have to fear that a third party treats them unfairly. To connect physical assets to blockchain protocols, the most common approach is to trust an asset custodian or a number of asset custodians. The asset custodian follows strict regulatory protocols and can, in some cases, be required to hold tokens that represent collateral, and if they break their promises, the tokens that represent collateral could be taken from them.

Embodiments comprises a method of exchanging assets between a plurality of parties, each party having an asset to exchange for another asset, the method comprising:
converting assets of each of the parties into bridge assets owned by the respective parties and represented in a transaction system,
converting said system bridge assets of the respective parties to target assets requested by said parties.

Embodiments comprise a system of exchanging assets between a plurality of parties, each party having an asset to exchange for another asset, the system comprising computer program code portions adapted to:
convert assets of each of the parties into bridge assets owned by the respective parties and represented in a transaction system,
convert said system bridge assets of the respective parties to target assets requested by said parties.

Embodiments of methods and systems further comprises one or more of the following features and functions:
the bridge assets are backed by a collection of other assets;
for every backing collateral asset quantity the system maintains, the ratio between that collateral asset quantity and a circulating supply of the bridge asset is defined;
the system exchanges quantities of backing collateral assets with bridge assets, according to a set of predetermined relations or rules, which we refer to as the conversion relation or collateralization ratio;
the conversion ratio is unchanged when the system is configured to have a stationary backing;
on an exchange with collateral assets and the bridge asset, all the collateral assets are exchanged as one trade;
on exchanges when the system acts as counterparty, the exchange between the backing assets and the bridge asset happens simultaneously, where several trades are bundled into one;
a collection of the backing collateral assets has been locked such that they can be extracted from the system as a result of a successful transaction or auction that fulfills the conversion relation;
the lock is a cryptographic lock or hash proof lock;
the lock is maintained by a distributed decentralized blockchain system

### BRIEF DESCRIPTION OF THE DRAWINGS

Embodiments of the present disclosure will be described in more detail with reference to the accompanying drawings, where:

FIG. 1 is a schematic and very simplified illustration of an exchange in the system where 3 parties exchange 3 different assets, where a direct exchange is not possible.

FIG. 2 is a schematic illustration of components in a system for asset conversions.

FIG. 3 is a schematic illustration of actors exchanging collateral assets for bridge assets.

FIG. 4 is a schematic illustration of actors exchanging bridge assets for collateral assets.

FIG. 5a is a schematic illustration of the algorithm flow and comparisons to do multilateral order matching.

FIG. 5b is a more detailed schematic illustration of implementation of the algorithm flow and comparisons to do multilateral order matching.

FIG. 5c is an alternative schematic illustration of the algorithm flow and comparisons to do multilateral order matching.

FIG. 6 is a schematic illustration of a setup of the system described in Example 2 in the detailed description.

FIG. 7 is a schematic representation of a decentralized ledger system that can process the exchange

### DETAILED DESCRIPTION OF EMBODIMENTS AS PRESENTLY PREFERRED

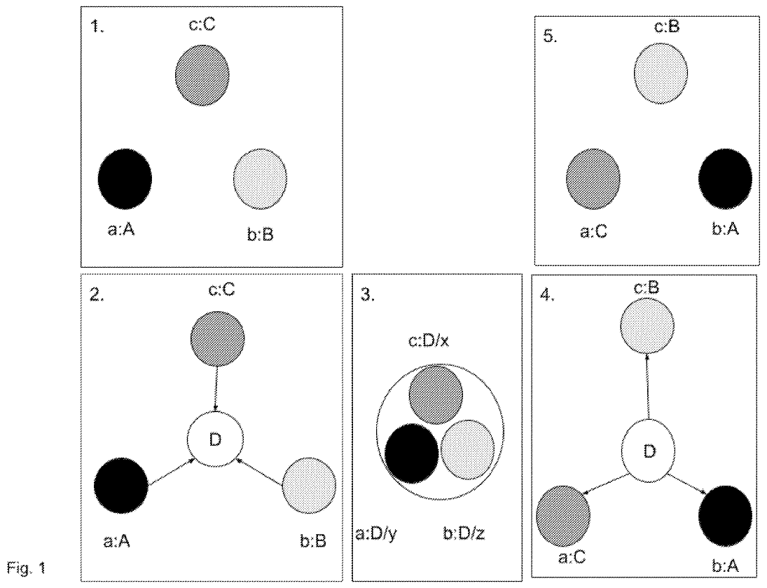

Embodiments will now be described with reference to FIG. 1, schematically showing a multilateral exchange between 3 parties. It will be understood that embodiments are not restricted to the above described and illustrated examples and that modifications can be made.

FIG. 1 illustrates an exchange, where actor a exchanges asset A with C, where actor b exchanges asset B with A, where actor c exchanges asset C with B. In a conventional exchange system the transition from step (1.) to (5.) cannot happen without intermediate steps where another actor acting as the counterparty for each of the trades. Embodiments presented herein comprises a technical system that solves this problem by connecting the parties together and performing steps (2.)-(4.)

The initial state is described in box (1.) of FIG. 1. Actor a owns asset A (black circle), actor b owns asset B (light grey circle), and actor c owns asset C (dark grey circle). The next state (2.) illustrates how each actor is connected to the bridge asset D (no units of D have been created at this state). The next state (3.) illustrates that actor a did deposit asset A and received 1/y quantity of D, that actor b did deposit asset B and received 1/z quantity of D, and that actor c did deposit C and receive 1/x quantity of D. Bridge asset D represents a claim on deposited collateral assets, where a greater quantity represents a greater claim. The next state (4.) illustrates a state where actor a used 1/y quantity of D to claim asset C, where actor b used 1/z quantity of D to claim asset A, and where actor c used 1/x quantity of D to claim asset B (no units of D exists at this state). The next state (5.) illustrates the completion of the multilateral exchange, where actor a owns asset C (dark grey circle), actor b owns asset A (black circle), and actor c owns asset B (light grey circle). In this state, the exchange intentions of the actors have been fulfilled.

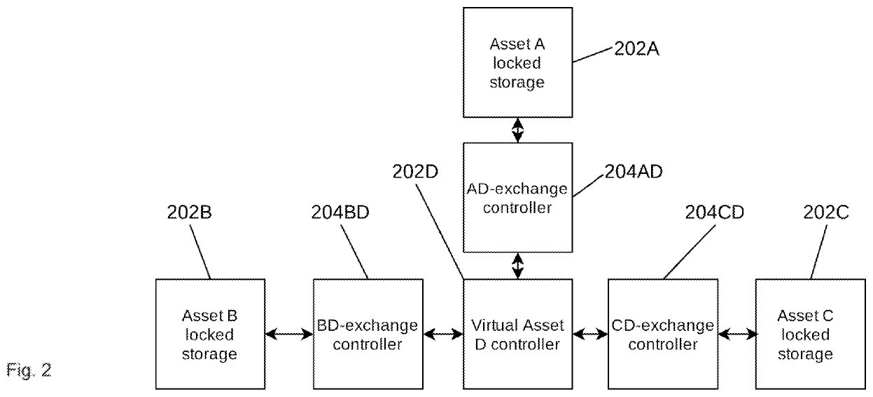

The aforementioned description of FIG. 1 can be extended, to explain a possible implementation of the system with conversions of three assets A, B and C as in embodiments schematically shown in FIG. 2. The system consists of locked storage or a physical or digital representation of assets A 202A, B 202B and C 202C, and a virtual Asset D controller 202D which can contain the other assets A, B and C at the predefined ratios. The locked storage 202A-202C can in the case of physical assets be a box with an electromechanical lock connected to a data system. In the case of digital assets the locked storage can be a cryptographic securely signed transaction of initiating a conversion. The virtual Asset D controller 202D is a digital representation of the other assets which can be proven to exist with cryptographic proofs on either a centralized or decentralized ledger. Exchange controllers are provided for controlling the exchange between each of the assets A, B, C with D, respectively, that is an AD-exchange controller 204AD, a BD-exchange controller 204BD and a CD-exchange controller 204CD.

Embodiments of the system can also (not shown in drawings) contain an optional exchange controller for each Asset type, an order book determining bids and ask prices for the conversions to enable other conversions directly with other actors than conversions with the system and the virtual Asset D controller directly. The exchange controller also serves as a way of storing, ordering and prioritizing orders that are not able to convert directly in the system. Each exchange controller in the system represents a market: the AD-market, BD-market, and CD-market.

The data execution of the system can, as in some embodiments, be done on centralized ledgers that all actors trust with either cryptographically secured transactions or not. However, the system as in other embodiments, provides the parties with the most trust when run in a decentralized fashion on a blockchain or other Distributed Ledger Technologies such as Directed Acyclic Graphs where every actor can run their own copy and verification of each step in the transaction. Assets and quantities can either be represented by an account based model with numbers representing quantities for every asset and actor or as unique hashes and unspent transaction output representing a chain of ownership with the use of Digital Signatures.

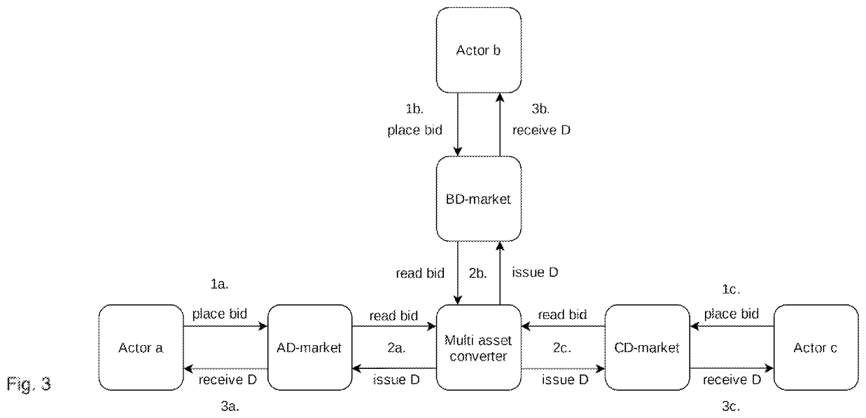

FIG. 3 exemplifies schematically the execution steps of such a system in as illustrated in FIG. 2 for the creation of the virtual Asset D. An actor a shows its exchange intent on the AD-market, actor b shows its exchange intent on the BD-market and actor c shows its intent on the CD-market by placing a bid. When the system agrees that the intentions of actors a, b, c align, according to the predefined relations, the system produces D, issues D to the relevant ratio to the respective actors a, b, c and takes the A,B and C assets as collateral. Steps 1-3 from FIG. 1 are annotated in the representation as (1a)-(3a) for actor a, (1b)-(3b) for actor b and (1c)-(3c) for actor c.

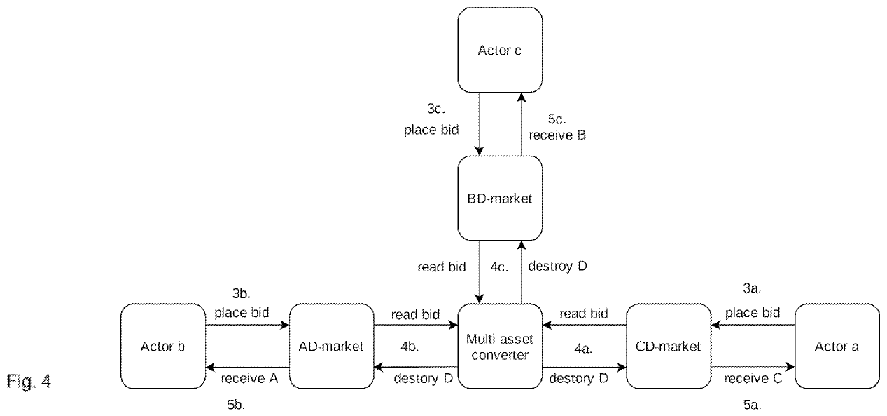

Similarly, in FIG. 4, actor a shows its exchange intent on the CD-market, actor b shows its exchange intent on the AD-market and actor c shows its exchange intent on the BD-market. When the system agrees that the intentions of actors a, b, c align, according to the predefined collateralization relation, the system destroys D and distributes the Assets A, B and C to the parties at the predefined exchange rate. Steps 3-5 from FIG. 1 are annotated in the representation as (3a)-(5a) for actor a, (3b)-(5b) for actor b and (3c)-(5c) for actor c.

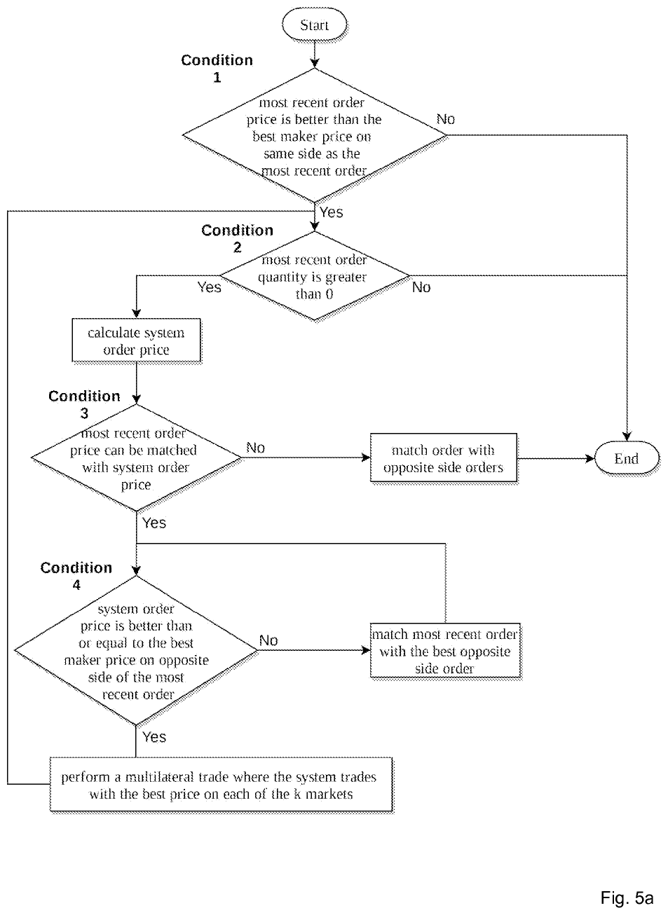

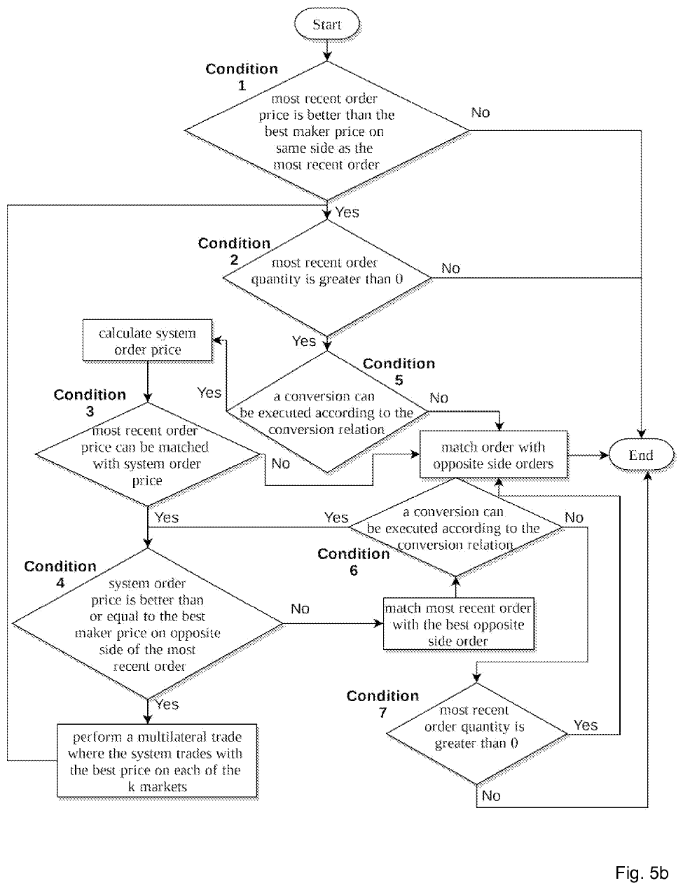

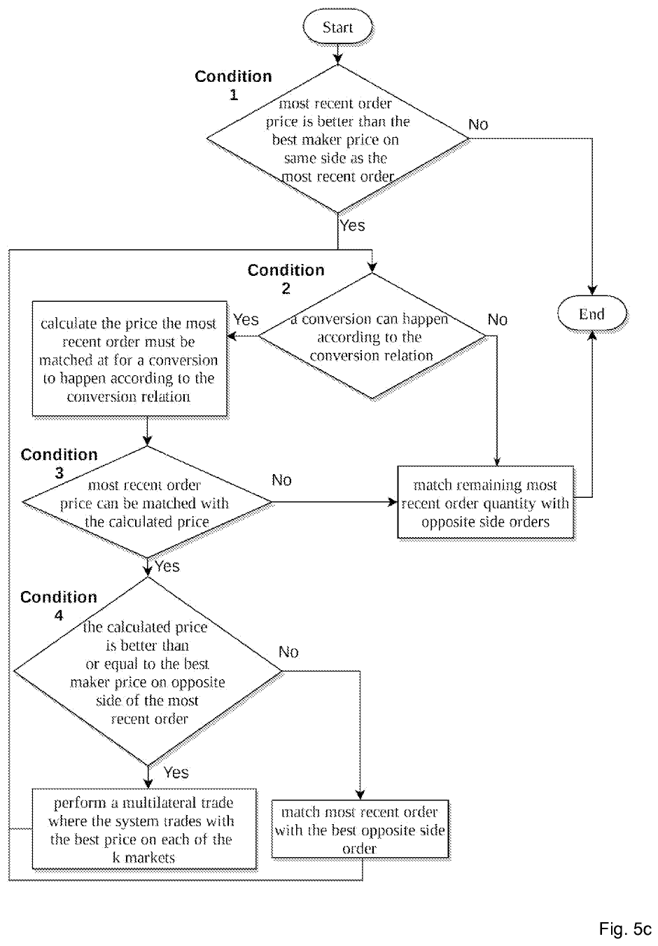

FIG. 5a, FIG. 5b and FIG. 5c shows the program flow and execution of multilateral order matching schematically. An actor submits an order to a market system, and this order is henceforth referred to as the most recent order.

Condition 1 represents comparing the most recent order price, with the prices of orders with the same type. If the most recent order is a sell order, the comparison is between the most recent order price and the first-in-queue sell order price i.e., the ask price. If the most recent order is a buy order, the comparison is between the most recent order price and the first-in-queue buy order price i.e., the bid price. The best price on a market is the price that is most beneficial to the other party of the trade. The best sell price is the lowest sell order price which is also called the ask price, and the best buy price is the highest buy order price which is also called the bid price.

Condition 2 represents checking the order quantity of the most recent order. The order quantity signifies how many units the actor has left to trade. When the most recent order quantity is greater than 0, a system order price is calculated. A system order is an order placed by the system, where the system acts as counterparty according to the algorithm. When the order quantity is 0, it means that the actor's trading intention has been met, and the execution can stop.

Condition 3 represents checking the relation between the newly generated system order and the most recent order. At this point, a system order price has been calculated. The system order price is calculated to maintain the collateralization relation. If the system order does not match with the most recent order, the execution must stop. If a price can be matched with another price, it means that the sell order price is lower than or equal to the buy order price.

Condition 4 represents comparing the system order price with the opposite order price. If the system order is a sell order, the comparison is between the system order price and the ask price. If the system order is a buy order, the comparison is between the system price and the bid price. The most recent order is given the best possible price, so it is, therefore, matched with the opposite order price if it is more beneficial than matching with the system order price.

Lastly, a multilateral order matching occurs. The system matches a quantity with the most recent order, and also a quantity with the first-in-queue orders on each of the k markets (there are k collateral assets). The matched quantities maintain the collateralization relation.

### EXAMPLES OF EMBODIMENT IMPLEMENTATION

### Example 1

Embodiments comprise a machine for exchange of physical goods, different types of balls. In a scenario actor a owns a football (represented by A), actor b a two basketballs (represented by B) and actor c three tennis balls (represented by C). Actor a would like to have its football exchanged for two tennis balls, b one of its basketballs exchanged for a football and c two of its tennis balls exchanged for a basketball.

None of the parties are able to directly exchange their existing items into their requested items. Actors a, b and c agree on using a machine based on one or more of the presented embodiments. They define the ratio between the system units and their items in a relation as one bridge asset unit of the system is equal to one football, which is equal to one basketball which is equal to two tennis balls. They place their respective balls into the machine, and the machine locks them in giving them a receipt of their ball deposit that only they would be able to claim back in case they would like to withdraw from the exchange. When everyone has deposited their ball, the system converts their ball deposit into a universal claim of one unit of the system as was the predefined exchange rate of the system. The balls will now be locked into the machine and not possible to withdraw until the actors have placed requests that match the predefined conversion ratio of the system. Actor a then makes a claim that it would like to withdraw two tennis balls from the system, actor b one football and actor c one basketball. The system converts their claim of one unit of the system to a key with which they are able to collect their requested items from the machine.

In the above example, the asset quantities that were deposited were equal to the exchange rate of a system unit. It is also possible to have the requested conversion be different than the system conversion rate. In that case, one actor pays more, as for example actor a pays one football for only half a system unit and actor c two tennis balls for one and a half system unit. In that case actor a's one football could be converted to one tennis ball and actor c would be able to get both a basketball and one of its tennis balls back from the machine if the second withdrawal request matches.

### Example 2

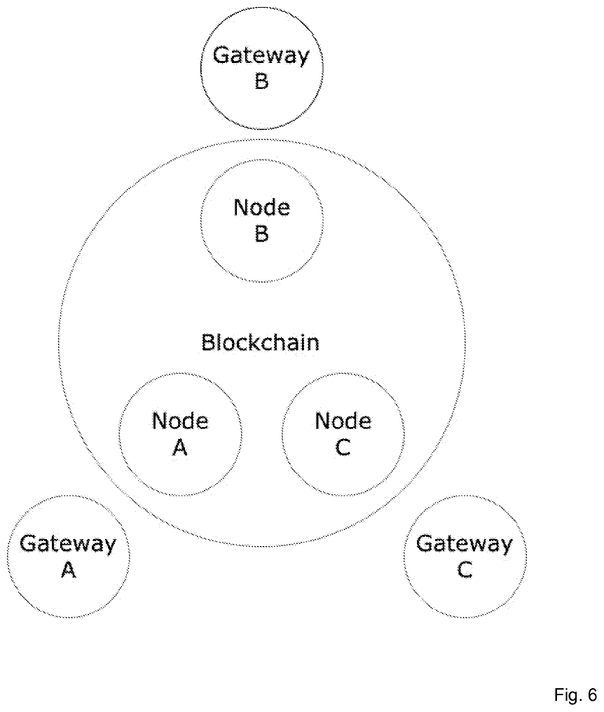

Embodiments comprise an algorithm that manages the supply and collateral of a multi-asset-backed virtual currency and enables multi-currency exchanges. The system uses a blockchain to execute the method described in a decentralized fashion as shown in FIG. 6.

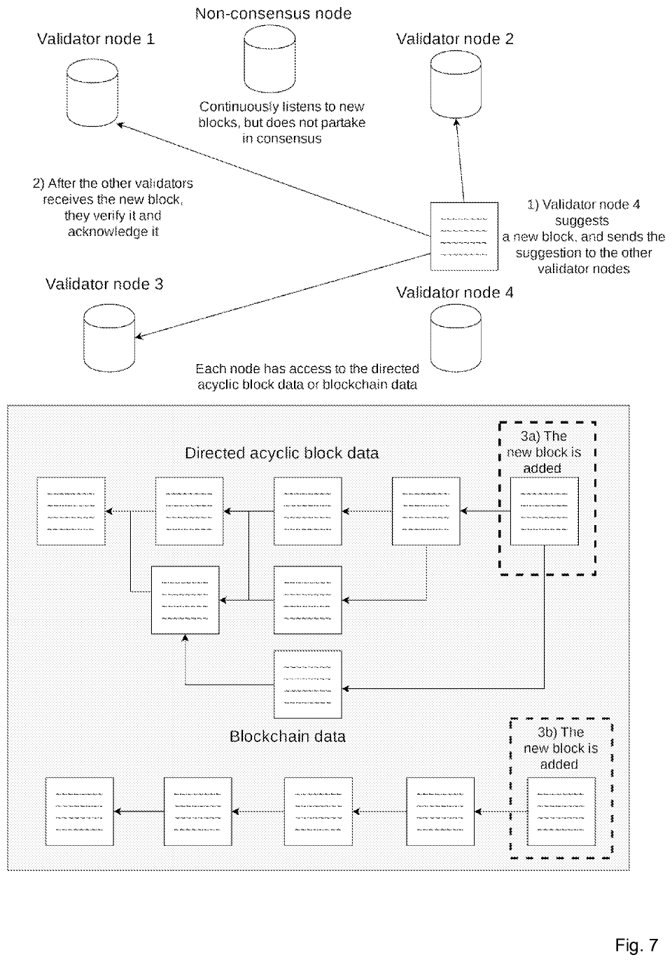

FIG. 7 displays details of an assets exchange system run on a decentralized ledger system. Such a decentralized ledger system can be run on a computer with memory, CPU, disk drive storage, server capability and interconnecting mechanism. A decentralized ledger system works by having validators produce blocks and then let other validators confirm those blocks. The blocks contain transaction information. Transaction information could include transfers of tokens and order matching. If an order book is implemented on a decentralized ledger, it is referred to as a decentralized exchange and the ledger will show a record of which orders were placed and whether they were filled or canceled. The matching engine could be embedded in the blockchain protocol or could be an add-on service enabled via smart contracts. Smart contracts are user-generated executable code that some blockchain protocols support. In FIG. 7, the Validator node 4 proposes a block (1.) and the other validators receive the block (2.). They then verify the block's validity by checking if the transactions contained within it are legal, i.e., if the transactions does not violate any of the protocol or smart contract rules, and if the transactions can be added to the block data storage without violating any previous transactions (such as double-spending). Once the block has been produced and validated, it is added to the block data storage. The block data storage could be either a directed acyclic graph (3a.) or a blockchain (3b.) or similar cryptographically secured reference structure.

The system enables global payments through its gateway system. Every party has a gateway bridging a traditional financial ledger and the blockchain solution. The blockchain solution is decentralized in such a way that every party can run a node in the system. The economic system is built around a virtual currency backed by a basket of collateral assets. The decentralized exchange uses an exchange currency called D. D is a virtual currency that is backed by k assets A1, A2, . . . , Ak. The collection of assets the system owns is a collateral basket, in this embodiment referred to as collateral. The collateral basket distribution is defined by a vector of k weights w=(w1, w2, . . . , wk). The ratio between wi and wj, defines the relation that should be between collateral quantities of Ai and Aj. The difference between the current collateral quantity of Ai and the weight wi, is defined as Ki, and since each such factor is equal, they can all be referred to as K. The supply weight which is fixed, is denoted as u, and the supply growth factor is denoted as η. The supply growth factor is how many times greater the circulating supply of D is compared to the supply weight.

Conversions can have minimum size, which is defined by the supply weight u. It means that each conversion contains u times a factor (which is an integer greater than or equal to one units of bridge asset. The conversion relation could also be stated as: u unit(s) of bridge asset can be converted to w1 unit(s) of the first backing asset, w2 unit(s) of the second backing asset, . . . , and wk unit(s) of the last backing asset. And w1 unit(s) of the first backing asset, w2 unit(s) of units of the second backing asset, . . . , and wk unit(s) of the last backing asset can be used to generate u unit(s) of bridge asset.

Trades happen exclusively between D and other currencies. This is defined as a currency pair, where the asset is the base currency, and D is the quote currency. Prices on markets are defined in the quotation Ai/D, which means how many D that is required to buy or sell one unit of Ai. A maker is the party of a trade that places an order. A taker is the party of a trade that fills an order. An ask order means that a maker is selling an asset that is not D. A bid order means that a maker is buying an asset that is not D.

The equilibrium target price level is the set of market prices on the k markets, where there is a possible combination of prices v1, v2, . . . , vk such that the system maintains the collateralization relation, if it were to perform a multilateral trade using prices v1, v2, . . . , vk. The algorithm either generates or liquidates D when there exists at least one order on all of k markets where the system can perform a multilateral trade while maintaining the target collateralization relation. The target collateralization level is the collateralization level that is defined by the collateralization relation. This price level is also denoted as the activation price level.

If Ai is backed by another real or digital currency, for example a national currency, there exists a gateway that issues Ai. For every Ai that a gateway issues, it maintains an equivalent amount of national currency. When an end user wants to perform a trade, exchange or payment of one currency into another, it can interact with gateways. Gateways are able to work as intermediaries, and in such instances, they are responsible for performing the asset exchange. For this use case, end users are not required to interact with the blockchain themselves.

One of the primary use cases of the protocol is to let end users use the gateway infrastructure to transact from one asset to another. For example, a user wants to transfer x amount of Aj to a foreign bank account. The user sends a request to a gateway gAi. Gateway gAi can use the current exchange rates to calculate an offer for the user. The user can then send the required amount of Ai to gateway gAi. Gateway gAi acquires x amount of Aj by trading on the exchange and transfers it to gAj. When gAj has received x amount of Aj it sends x amount of Aj to the bank account that corresponds with the user request.

A gateway can complete the following steps to send the payment:
1. gAi issues z amount of Ai.
2. gAi sells z amount of Ai for y amount of D on AiD-market.
3. gAi buys x amount of Aj for y amount of D on AjD-market.
4. gAi transfers x amount of Aj to gAj.

If the gateway already has z amount of Ai, it can skip step 1. If the gateway already has y amount of D, it can skip steps 1-2. If the gateway already has x amount of Aj, it can skip steps 1-3. If the gateway can anticipate the volume of Aj, it has to send it can complete the steps beforehand. Gateways also have the option of performing step 2-3 atomically, such that they are never exposed to D.

Gateways can after having gathered data, be able to estimate the incoming volume, to optimize the amount of D they hold at any given time. If D has a stable value, gateways can become more effective at performing the transaction steps while limiting their risk exposure.

When gateways interact with the system, they use the multilateral order matching system (i.e., the multi asset converter). In the multilateral order matching system, D always strictly maintains the collateralization relation by trading with many parties. A benefit with this approach is that it does not require each user to own k assets to create D. Users place bids, and when the bids align at the target activation price level, the system takes the bids. There can be k independent actors, all wanting to buy D, each of them using a different asset in the basket, and they are still able to synchronize using the system.

When a new order arrives (the most recent order), the algorithm compares the highest bid orders, or the lowest ask orders, on the k−1 other markets, with the price of the most recent order, to see if it could fill the other orders at the target activation price level. If it finds a match, it chooses the maximum order quantity that satisfies the target collateralization level and fills the most recent order together with the other orders simultaneously.

The most recent order has a limit price. The most recent order is matched at the best price possible that is within the limit, meaning that the matching price is better than or as good as the order's limit price. The most recent order receives a price within that range, such that the combining order prices in the multilateral trade matches the target activation price level, such that the target collateralization level will be maintained and the trade happens according to the conversion relation. Thus, the virtual currency D always maintains the same collateralization level precisely in terms of how many units of collateral assets each D corresponds to. If there exists buys or sells on each market, there will always exist potential system orders on each market that also can execute.

In embodiments the algorithm comprises the following steps and functions:
1. A user places an order (the most recent order) on market i.
2. If the most recent order price is better than the best order price in that order book, go to the next step else go to step 13. (Condition 1 in FIG. 5a)
3. If the order quantity of the most recent order is greater than a minimally defined tradeable asset for the system, go to the next step else go to step 13. (Condition 2 in FIG. 5a)
4. If there exists orders on every other market that is not the i-th market (k−1 markets), go to the next step else go to step 13.
5. Calculate system order price in FIG. 5a in accordance with a set of predetermined rules.
6. If the D quantity in the i-th system order is greater than a minimally defined order, go to the next step else go to step 13.
7. Calculate the price of the i-th system order, given the asset quantity relative to the collateralization relation for the least common denominator and the D quantity calculated in step 5.
8. If the i-th system order can be matched with the most recent order go to the next step else go to step 13 (Condition 3 in FIG. 5a).
9. While the user can receive a better price by performing regular trades, perform those trades and update the most recent order quantity. (Condition 4 in FIG. 5a).
10. If the most recent order quantity is greater than the minimum system tradable quantity, go to the next step else go to step 13.
11. Perform a multilateral trade in FIG. 5a in accordance with a set of predetermined rules.
12. Go to step 3.
13. If most recent order quantity is greater than the minimum system tradable quantity, place most recent order in order book

A more detailed description of the algorithm is presented in FIG. 5b and an alternative implementation is presented in FIG. 5c.

Multilateral order matching, where the system sells collateral, can occur only when the following conditions are true. When the system instead buys collateral, and the most recent order is a sell order, the conditions must be changed to fit that scenario.
a. The most recent buy order must have a higher price than the highest bid order.
b. The most recent buy order, combined with bid orders on the i-th market, must have a combined asset quantity that is greater than or equal to the i-th weight.
c. On every other market j that is not the i-th market (k−1 markets), market actors must be buying an asset quantity that is greater than or equal to j-th weight.
d. The i-th system order must have a D quantity that is greater than or equal to 0.
e. The i-th system order must have a price that is greater than the highest bid order.
f. The i-th system order must have a price that is less than or equal to the most recent buy order.
g. The i-th system order must have a price that is less than or equal to the lowest ask order.

Condition a is the first condition the algorithm evaluates, to see if it should generate a system order or not. The algorithm should not be able to favorize newer orders over older orders, as that would make the system unusable. It is possible to implement a check to prune some of the cases and thus make the algorithm faster. Even if the check is not implemented, this should never occur, since a bid order that triggers a multilateral trade and has a lower or equal price to the highest bid order price cannot exist, as that would imply that the highest bid order would have been filled by a previous multilateral order matching event.

Condition b, c, and d all need to be true for the exchange to occur. The algorithm needs to swap x*w1 amount of A1, . . . , x*wk amount of Ak for x*u amount of D. Condition b and c implies that it is possible to combine buy orders to reach the minimum quantity defined by the weights. Another possible implementation is to set a minimum asset quantity size and cancel too small orders, such that each multilateral trade has an asset quantity greater than or equal to the weight associated with that market.

If condition d is true, it means that it is possible to create a system order, as filling the orders on the other markets would not mean that the wrong quantity of D was either created or destroyed. There is no need to check if condition e is fulfilled, for the same reason as previously mentioned, the highest bid order would have already been filled previously and it is therefore not possible that the condition is false.

Condition f and g on the other hand must preferably be checked. When considering condition f, we see that it is possible that a system order is generated with a price that the user is not willing to accept. Concerning condition g, the algorithm compares the lowest ask order on the opposite side of the most recent order with the i-th system order. Users place limit orders and a limit order is a system command that gives users the best possible price that does not exceed the limit. If the user can receive a better price by performing a regular trade, the algorithm must match those orders first.

Preferably, the method should always fill orders that are aligned at the activation price level. After each iteration, a check is performed that orders on the activation price level cannot be found. In this way, it is verified that the order matching is complete and maximal. Lastly it is verified that the system only performs conversions in accordance with the conversion relation i.e. it maintains the target collateralization level and target collateral basket distribution.

Embodiments as described herein finds a set of matching orders each iteration and fills the maximum quantity. It continues while the most recent order still contains asset quantity, which could theoretically be long enough to fill the entirety of possible orders, which is either the bid orders or the ask orders on the k−1 other markets where the most recent order was not placed. The set of p possible makers orders is defined as Z={o1, . . . , op}. The worst-case is if one order is canceled per iteration. The maximum number of iterations is p−(k−1). On each iteration, k comparisons and k blockchain trades are performed. Thus, the worst-case time complexity is O((|Z|−(k−1))*k). The most time-consuming part of the computation should be the blockchain trades. These trades can be collected into one special kind of trade operation and thus enhance the blockchain performance.

The weights determine the composition of assets that the algorithm maintains. The weights can change gradually such that the multilateral order matching remains operational during the rebalancing phase. Weights can be defined in terms of the collateral to allow a certain degree of overcollateralization during the rebalancing phase. The relationship for each weight wi, to the collateral li and to the supply weight u and supply M is defined as wi=li*u/M, when there is no overcollateralization. The formula for computing the weights are wi=floor(li/η). To get an integer approximation of wi the floor-operation can be used. The greater the weight, the less impact the floor-operation has. The process of letting the weights depend on the other parameters are defined as dynamic weights.

The rebalancing must be based on a set of defined targets weights. The dynamic weights can gradually be updated to match the target weights. The rebalancing is complete, either when the dynamic weights match the target weights, or when the collateral precisely matches what is defined by the target weights, which is defined as the target collateral composition. The defined target weights can also be calculated based on trades occurring in the system and towards a parametric goal to reach. The defined target weights can also be based on the value of the collateral, such that the target changes as the collateral increases or decreases in value.

For each rebalancing state, there is a possible change to the current collateral composition, that would produce the target collateral composition. Each collateral quantity can be subtracted from the target collateral quantity to find this difference. If the collateral quantities would be changed by precisely these quantities atomically, that is defined as the optimal state change. The proposed rebalancing algorithm aims to perform the optimal state change, but if it is not possible, it instead performs intermediate state changes, where the change to each collateral quantity uniformly corresponds with the optimal state change, such that the ratio between the collateral quantity difference defined by the optimal state change and the actual change to the collateral quantity, is the same for each collateral asset.

There is also an option to define the supply weight dynamically, such that each rebalancing event leads to gradual inflation or deflation. The supply weight change would correspond to the uniform collateral change, such that the ratio between the supply change and the optimal supply change, is the same as the ratio for each collateral asset during a rebalancing event. Each rebalancing event is triggered when the system handles the most recent order. The most recent order receives a matching price that is the result of fulfilling the state change according to the rules mentioned above. This price must be better, from the perspective of the user that placed the most recent order, than any other possible order it could have received using the other possible trading options, such as multilateral trading or regular trading.

There is also the possibility to define the state change not to produce a uniform change, but a unison change according to some other predetermined function or rule.

The system and the method can technically be performed with different actions as follows:

Every user that has authority to change the system state has a private key. The private key is a string that was generated by the user and to ensure that only that user can perform system state updates using that private key, the user keeps this information a secret. An account can be associated with one or many private keys. If the account is associated with many private keys, it is called a multi-signature. To change the system state, either every private key in the multi-signature, or only a subset is needed, and the size of the subset is defined by a threshold number.

In some embodiments, the account balance information is public, in other embodiments, viewing the account balance information may require authorization. The account balance shows how many units of assets a user owns. The number of units is represented as an integer in the system. The amount of units the user owns of a specific asset is a subset of the circulating supply of that specific asset. To perform some function in the system, the user(s) signs a message and submits the message to one of the validators. The validators then include it in a block and the system state changes.

The system also has an account, and in some embodiments, this account has no private key associated with it, and other embodiments, the account is protected by a multi-signature and the people or organizations that is part of that multi-signature, have been carefully selected and is only allowed access and change the system state during specific times, mainly to perform maintenance.

When exchanges occur between users or between users and the system, the units are transferred between the accounts simultaneously. After an exchange has occurred, the account balances have been updated.

Every asset in the system is represented in the same way, i.e., they can be viewed in users account balances where the asset name is associated with the number of units that the account owns.

When an asset is transferred or exchanged in the system, it means that a new block has been generated and added to the blockchain. When the blockchain reaches a finality state, a subset of validators agree that the state of the blockchain cannot change. At that point, the blockchain transfer or exchange can be seen as completed. If the token is backed by a physical asset, the token owner can give a quantity of tokens to an asset custodian (who may reside in an external system), and the asset custodian will then transfer the physical asset to the new owner. At that point, the full exchange or transfer has been completed.

If the asset custodian resides in an external blockchain system, then there must be a connection between the internal and external blockchain system. The internal blockchain system is the system where the invention is implemented and deployed. A connection can be created using various cross-chain communication protocols and techniques, such as atomic swaps. An asset quantity is then deposited into a contract in the external system and a virtual copy of the asset is created in the internal system with the same number of units that was deposited into the contract. While the virtual copy units are used in the internal system the corresponding units in the external system are locked. When a user decides to move their value to the external system the virtual copy units are destroyed and the corresponding units in the external system are unlocked and can be sent to an account on the external system that user controls.

User bids are placed in the order book and the system can always read the state of the order book. When a new bid enters the order book, the system checks how many collateral asset units it would receive if it were to participate in the trade, or how many bridge asset units it would receive, and similarly, how many bridge asset units it would have to pay or how many collateral asset units it would have to pay. The system will produce an offer to the last bidder such that a conversion can happen according to the conversion relation. The system will automatically execute on the offer if the last bidder receives a better price than it could get from trading with other users instead of the system. If the system cannot produce an offer to the last bidder, because it lacks either bridge asset units or collateral asset units, to produce a conversion according to the conversion relation, then the bidders could cancel their bids, by sending a signed message to one of the validators, or they could add new bids by sending a signed message to one of the validators, until the system can agree and produce a system conversion according to the conversion relation.

When the system performs a multilateral order match, then all the user accounts that are involved in the trade, including the system account, get updated with new balance information in the same transaction, and the state of the orders that pertain to the exchange in the order book, will also be updated within the transaction. Each block in a blockchain contains an ordered list of transactions and the state of each transaction depends on the previous transaction. Since the whole conversion happens within one transaction, it is not possible that an incomplete transaction occurs, and since the backing of the bridge asset depends on this, the system can assure that each bridge asset is always backed according to the conversion relation.

In some embodiments of the system, the system is a distributed decentralized blockchain system. In versions of the system assets are locked by cryptographic signatures by use of private and public key pairs.

A blockchain runs on a distributed and decentralized system of nodes, and these nodes are operational all the time. A new block is added, in some embodiments, at a specific rate, and in other embodiments, only when users send signed transactions to validator nodes. When a validator node receives a signed transaction, the validator node then includes it in a block and then the block is appended to the blockchain, with a reference to the previous block. A block hash is computed by combining the previous block hash with the Merkle root of the transactions in the block, which is a specific hash that is based on the transaction hashes, and each transaction hash is based on the information that is contained within the transaction. The block hashes are, therefore, linked to the order of blocks and the information contained within transactions. This makes it easier for validator nodes to synchronize and verify that the blockchain has one shared state.

A blockchain state change is the processes of adding new information to the blockchain. And new information is added by users sending signed transactions to the blockchain. The blockchain state is all the information in the blockchain combined, where newer information is prioritized over older information.

In some embodiments, the decentralized exchange is a feature that is embedded in the blockchain protocol, in other embodiments, it is implemented as a smart contract or as a number of smart contracts. A smart contract is executable code that can be submitted to the blockchain by users, and by using smart contracts, the blockchain protocol logic is separated from the feature logic. The decentralized exchange is an order matching engine. It allows users to submit orders that could be either sell orders or buy orders. If a user submits a sell order, the user specifies the quantity of a specific asset they want to sell and a limit, which is how much bridge asset quantity they want in return. If a user submits a buy order, the user specifies the quantity of a specific asset they want to buy and a limit, which is how much bridge asset quantity they are willing to pay. When a user submits a sell order, they may receive more bridge asset quantity than what they specified as their limit, but not less. When a user submits a buy order, they may have to pay less bridge asset than what they specified as their limit, but not more.

The multilateral order matching algorithm (i.e. the conversion algorithm and/or the rebalancing algorithm), will receive the sell order or buy order first, before it is submitted to the order book. It then proceeds to analyze the relevant orders that currently exist on the markets. It uses the information about how many circulating units of bridge assets that exist, and how many collateral asset units that exist. It then computes whether it can make a conversion trade or whether it can make a rebalancing trade. If it is possible to perform a multilateral order match, it creates system orders and bundles them together and then submits them as one transaction to the blockchain.

A blockchain in this meaning can also be any other type of distributed ledger such as a directed acyclic graph or other order ordering mechanism for transactions and blocks. A block can be any collection of transactions and events.

The present invention also relates to a computer program product comprising computer program code which, when executed by a system enables the system to perform the inventive method.

The present invention also relates to a computer readable medium carrying the inventive computer program code.

Embodiments are further described by the following list of features:
Feature 1: A system and a method where multiple parties can exchange assets that are not directly exchangeable by the multiple parties, by first converting them into an ownership of a bridge asset in the system and thereafter convert from the system bridge asset to the requested target asset.
Feature 2: A system and a method according to feature 1 where bridge assets are collateralized by a collection of the other assets.
Feature 3: A system and a method according to feature 2, where for every collateral asset quantity the system holds, the ratio between that collateral asset quantity and the circulating supply of the bridge asset is defined.
Feature 4: A system and a method according to any of the preceding features, where the system exchanges quantities of collateral assets with quantities of bridge assets, according to the relations presented in feature 3.
Feature 5: A system and a method according to any of the preceding features, where the system generates new bridge assets according to the relations presented in feature 3.
Feature 6: A system and a method according to any of the preceding features, where the system destroys bridge assets according to the relations presented in feature 3.
Feature 7: A system and a method according to any of the preceding features, where the system maintains collateral quantities and bridge asset supply, according the relations presented in feature 3.
Feature 8: A system and a method according to any of the preceding features, where the relations presented in feature 3 can be changed into new relations.
Feature 9: A system and a method according to any of the preceding features, where on an exchange with collateral assets and the bridge asset, all the collateral assets are exchanged as one trade.
Feature 10: A system and a method according to any of the features above where the collection of the collateral assets has been locked in a way that they are not possible to extract from the system in other ways than following the defined method.
Feature 11: A system and a method according to features 10 where the lock is a cryptographic lock or hash proof lock.
Feature 12: A system and a method according to any previous features where parties can compete on who gets to exchange their asset by informing the system and the other parties on exchange offers by an auction for bidders and sellers of collateral assets and where the system acts as a virtual agent for settling those exchanges most optimally.
Feature 13: A system and a method according to features 12, where the party that is giving the offer at a better exchange rate is prioritized over other parties and where, in the case of offers being placed at the same exchange rate, earlier offers are prioritized over later offers.
Feature 14: A system and a method according to any of the preceding features, where a system conversion of collateral assets to and from the bridge asset is triggered when the system has received an offer at a satisfying level in relation to the previously placed offers for all the other predetermined collateral assets and their specific predetermined ratio.
Feature 15: The system according to any of the preceding features, where the system does not accept a system conversion, the last offer is instead matched with previously placed opposite offers if possible.
Feature 16: The system according to any of the preceding features, where the system accepts a system conversion and the last offer was only partly fulfilled, the part not fulfilled is instead matched with previously placed opposite offers if possible
Feature 17: A system and a method according to any of the preceding features 12-16, where both a system conversion and non-system conversions are possible at the same exchange rate, the system conversion is prioritized over exchanges between just two parties.
Feature 18: A system and a method according to any of the preceding features, where the system accepts a system conversion, it gives the best possible exchange of quantities to the last bidder, of all the possible exchanges that fulfills the collateral relations presented in feature 3 and the possible direct exchanges.
Feature 19: A system according to any of the previous features where the execution of the exchange is executed and recorded by using decentralized ledger technology such as a blockchain or direct acyclic graph.
Feature 20: A system according to any of the previous features where a collateral asset can be any physical item such as a ball, car or dog and multiplicities of such items.
Feature 21: A system according to any of the previous features where a collateral asset can be any digital or virtual item or representation thereof, or representation of other physical items or parts thereof e.g. a share, currency unit, token or bond.
Feature 22: A system and a method according to any of the previous features where a collateral asset to exchange can be another bridge asset in the system or another system, enabling more complex conversions in a chain of bridge asset conversions.
Feature 23: A system and a method according to any of the previous features, where the relations presented in feature 3 can change dynamically, as they are defined in terms of the current state of the collateral and supply.
Feature 24: A system and a method according to feature 23, where the relations presented in feature 3 can change during a rebalancing phase.
Feature 25: A system and a method according to feature 24, where the target relations that should be reached during the rebalancing phase can be defined.
Feature 26: A system and a method according to feature 25, where the relations presented in feature 3 change in unison according to a predefined rate.
Feature 27: A system and a method according to feature 26, where the rebalancing phase is continuous and updated continuously based on metrics within the system.
Feature 28: A system and a method according to any of the previous features, where the rebalancing is implemented as system conversions.
Feature 29: A system and a method according to any of the previous features, where the rebalancing is prioritized over regular system conversions.
Feature 30: A system and a method according to any of the previous features, where destruction of bridge assets are performed by liquidation, by being removed from the circulating supply and by releasing the underlying collateral.
Feature 31: A system and a method according to any of the previous features, where the opposite orders of a specific asset are defined as the sell orders of the specific asset if referencing the opposite orders of the buy orders of the specific asset and the buy orders of the specific asset if referencing the opposite orders of the sell orders of the specific asset.
Feature 32: A system and a method according to any of the previous features, where non-system conversions are exchanges where the system is not one of the parties of the trade, and where system conversions are exchanges where the system is one of the parties in the trade.

### ASPECTS OF THE INVENTION

Aspect 1: A method of exchanging assets between a plurality of parties, each party having an asset to exchange for a target asset, the method comprising:
converting assets of each of the parties into bridge assets owned by the respective parties and represented in a transaction system,
converting said system bridge assets of the respective parties to target assets requested by said parties.
Aspect 2: The method of aspect 1, wherein the bridge assets are collateralized by a collection of the other assets.
Aspect 3: The method of aspect 2, wherein for every collateral asset quantity the system holds, the ratio between that collateral asset quantity and a circulating supply of the bridge asset is defined.
Aspect 4: The method of any of the preceding aspects, wherein the system exchanges quantities of collateral assets with bridge assets, according to a set of predetermined relations or rules.
Aspect 5: The method of any of the preceding aspects, wherein on an exchange with collateral assets and the bridge asset, all the collateral assets are exchanged as one trade.
Aspect 6: The method of any of the preceding aspects, wherein a collection of the collateral assets has been locked such that they can be extracted from the system as a result of a successful transaction.
Aspect 7: The method of aspect 6, wherein the lock is a cryptographic lock or hash proof lock.
Aspect 8: A system of exchanging assets between a plurality of parties, each party having an asset to exchange for a target asset, the system comprising computer program code portions adapted to:
convert assets of each of the parties into bridge assets owned by the respective parties and represented in a transaction system,
convert said system bridge assets of the respective parties to target assets requested by said parties.
Aspect 9: The system of aspect 8, wherein the bridge assets are collateralized by a collection of the other assets.
Aspect 10: The system of aspect 9, wherein for every collateral asset quantity the system holds, the ratio between that collateral asset quantity and a circulating supply of the bridge asset is defined.
Aspect 11: The system of any of the preceding aspects 8 to 10, wherein the system comprises computer program code portions adapted to exchange quantities of collateral assets with bridge assets, according to a set of predetermined relations or rules.
Aspect 12: The system of any of the preceding aspects 8 to 11, wherein on an exchange with collateral assets and the bridge asset, all the collateral assets are exchanged as one trade.
Aspect 13: The system of any of the preceding aspects 8 to 12, wherein a collection of the collateral assets has been locked such that they can be extracted from the system as a result of a successful transaction.
Aspect 14: The system of aspects 13, wherein the lock is a cryptographic lock or hash proof lock.

It will be understood that embodiments disclosed herein are not limited to the described detailed examples and that modifications can be made within the scope of the accompanying claims and principles illustrated herein.

1-16. (canceled)

17. A method of exchanging assets between a plurality of parties, each party having an asset to exchange for a target asset, the method comprising:
converting assets of each of the parties into bridge assets owned by the respective parties and represented in a transaction system,
converting said system bridge assets of the respective parties to target assets requested by said parties,
wherein the bridge assets are collateralized by a collection of the other assets.

18. The method of claim 17, wherein for every collateral asset quantity the system holds, the ratio between that collateral asset quantity and a circulating supply of the bridge asset is defined.

19. The method of claim 17, wherein the system exchanges quantities of collateral assets with bridge assets, according to a set of predetermined relations or rules.

20. The method of claim 17, wherein on an exchange with collateral assets and the bridge asset, all the collateral assets are exchanged as one trade.

21. The method of claim 17, wherein a collection of the collateral assets has been locked such that they can be extracted from the system as a result of a successful transaction.

22. The method of claim 21, wherein the lock is a cryptographic lock or hash proof lock.

23. A system of exchanging assets between a plurality of parties, each party having an asset to exchange for a target asset, the system being adapted to:
convert assets of each of the parties into bridge assets owned by the respective parties and represented in a transaction system,
convert said system bridge assets of the respective parties to target assets requested by said parties,
wherein the system is adapted to collateralize the bridge assets by a collection of the other assets.

24. The system of claim 23, wherein the system is adapted to define the ratio between that collateral asset quantity and a circulating supply of the bridge asset for every collateral asset quantity the system holds.

25. The system of claim 23, wherein the system is adapted to exchange quantities of collateral assets with bridge assets, according to a set of predetermined relations or rules.

26. The system of claim 23, wherein the system is adapted to exchange all the collateral assets as one trade on an exchange with collateral assets and the bridge asset.

27. The system of claim 23, wherein the system is adapted to lock a collection of the collateral assets and extract them from the system as a result of a successful transaction.

28. The system of claim 27, wherein the system is adapted to use a cryptographic lock or hash proof lock to lock the collection of the collateral assets.

29. A computer program product comprising computer program code which, when executed by a system enables the system to perform the method according to claim 17.

30. A computer readable medium carrying computer program code according to claim 29.
